(19) United States
(12) Patent Application Publication
(10) Pub. No.: US 2003/0097395 A1
(43) Pub. Date: May 22, 2003

(54) Executing irregular parallel control structures

(76) Inventor: Paul M. Petersen, Champaign, IL (US)

Correspondence Address: Timothy N. Trop, TROP, PRUNER & HU, P.C., STE 100, 8554 KATY FWY, HOUSTON, TX, 77024-1805, US

(21) Appl. No.: 09/991,017

(22) Filed: Nov. 16, 2001

(51) Int. Cl. G06F 9/00

(52) U.S. Cl. 709/102

(57) ABSTRACT

In some embodiments of the present invention, a parallel computer system provides a plurality of threads that execute code structures. A method may be provided to allocate available work between the plurality of threads to reduce idle thread time and increase overall computational efficiency. An otherwise idle thread may enter a work stealing mode and may locate and execute code from other threads.

### BACKGROUND

The present invention relates to parallel computer systems and, more particularly, allocating work to a plurality of execution threads.

In order the achieve high performance execution of difficult and complex programs, for many years, scientists, engineers, and independent software vendors have turned to parallel processing computers and applications. Parallel processing computers typically use multiple processors to execute programs in a parallel fashion which typically produces results faster than if the programs were executed on a single processor.

In order to focus industry research and development, a number of companies and groups have banded together to form industry sponsored consortiums to advance or promote certain standards relating to parallel processing. The Open Multi-Processing (“OpenMP”) standard is one such standard that has been developed. OpenMP is a specification for programming shared memory multiprocessor computers (SMP).

One reason that OpenMP has been successful is due to its applicability to array based Fortran applications. In the case of Fortran programs, the identification of computationally intensive loops has been straightforward, and in many important cases, significant improvements in executing Fortran code on multiprocessor platforms has been readily obtained.

However, the use of the OpenMP architecture for applications, which are not Fortran based, has been much slower to gain acceptance. Typically, that is because these applications are not array based and do not easily lend themselves to being parallelized by programs such as compilers which were originally released for the OpenMP standard.

To address this issue, extensions to the OpenMP standard have been proposed and developed. Once such extension is the OpenMP workqueuing model. By utilizing the workqueuing extension model, programmers are able to parallelize a large number of preexisting programs that previously would have required a significant amount of restructuring.

To support this extension to OpenMP, a new concept of “work stealing” was developed. The work stealing model was designed to allow any thread to execute any task on any queue, which was created in a workqueue structure. Work stealing permits all threads started by a run time system to stay busy even when their particular tasks are finished executing.

The concept of work stealing is central to implementing workqueuing in an efficient manner. However, the original implementations of the work stealing concept, while a tremendous advancement in the art, were not optimized. As such, users were not able to fully realize the potential advantages provided by the workqueuing and work stealing concepts.

Therefore, there is still a significant need for a more efficient implementation of the work stealing model.

### BRIEF DESCRIPTION OF THE DRAWINGS

FIG. 1 is a flow chart of the program flow from source code to an initial thread activation list for a plurality of threads in accordance with one embodiment of the present invention.

FIG. 2 illustrates an overview of an algorithm for thread workflow in accordance with one embodiment of the present invention.

FIG. 3 illustrates nested taskq structures in accordance with one embodiment of the present invention.

FIG. 4 illustrates a flow chart for executing a taskq function in accordance with one embodiment of the present invention.

FIG. 5 illustrates a flow chart for a work steal process in accordance with one embodiment of the present invention.

FIG. 6 is a schematic depiction of a processor-based system in accordance with one embodiment of the present invention.

### DETAILED DESCRIPTION

In one embodiment of a computer system according to the present invention, a computer system takes as its input a parallel computer program that may be written in a common programming language. The input program may be converted to parallel form by annotating a corresponding sequential computer program with directives according to a parallelism specification such as OpenMP. These annotations designate, parallel regions of execution that may be executed by one or more threads, as well as how various program variables should be treated in parallel regions. The parallelism specification comprises a set of directives such as the directive “taskq” which will be explained in more detail below.

Any sequential regions, between parallel regions, are executed by a single thread. The transition from parallel execution to serial execution at the end of parallel region is similar to the transition on entry to a “taskq” construct. However, when transitioning out of a parallel region, the worker threads become idle, but when entering a “taskq” region, the worker threads become available for work stealing.

Typically, parallel regions may execute on different threads that may run on different physical processors in a parallel computer system, with one thread per processor. However, in some embodiments, multiple threads may execute on a single processor or vice versa.

To aid in understanding embodiments, a description of the taskq directive is as follows:

Logically, a taskq directive causes an empty queue of tasks to be created. The code inside a taskq block is executed single threaded. Any directives encountered while executing a taskq block are associated with that taskq. The unit of work (“task”) is logically enqueued on the queue created associated with the taskq construct and is logically dequeued and executed by any thread. A taskq task may be considered a task-generating task as described below.

Taskq directives may be nested, within another taskq block in which case a subordinate queue is created. The queues created logically form a tree structure that mirrors the dynamic nesting relationships of the taskq directives. The whole structure of queues resembles a logical tree of queues, where the root of the tree corresponds to the outermost task queue block, and the internal nodes are taskq blocks encountered dynamically inside a taskq or task block.

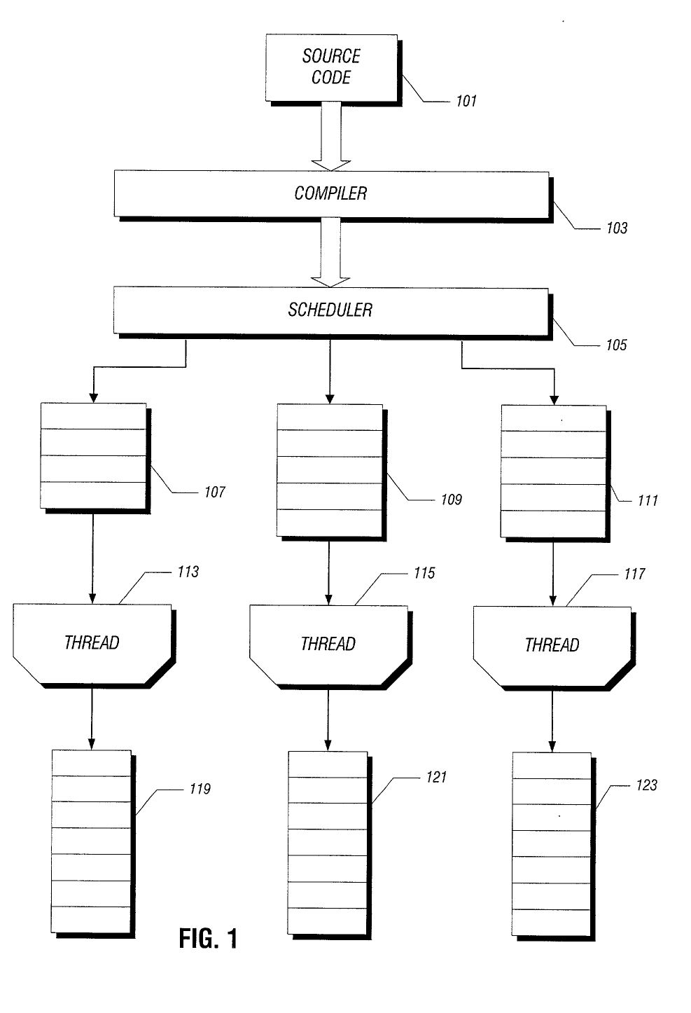

Referring now to FIG. 1, an input to the computer system 610 is the source code 101 which may be a parallel computer program written in a programming language such as, by way of example only, Fortran 90. However, the source code 101 may be written in other programming languages such a C or C++ as two examples. This program 101 may have been parallelized by annotating a corresponding sequential computer program with appropriate parallelizing directives. Alternatively, in some embodiments, source code 101 may be written in parallel format in the first instance.

The source code 101 may provide an input into a compiler 103 which compiles the source code into object code and may link the object code to an appropriate run time library, not shown. The resultant object code may be split into multiple execution segments such as 107, 109, and 111. These segments 107, 109, and 111 contain, among other instructions and directives, taskq instances that were detected in the source code 101.

The execution segments 107, 109 and 111 may be scheduled by scheduler 105 to be run on an owner thread of which 113, 115 and 117 are representative. As mentioned above, each of these threads may be run on individual processors, run on the same processor, or a combination of both.

Individual threads 113, 115, and 117 may begin to generate tasks, which may be stored in activation lists 119, 121, and 123, respectively, by executing taskq tasks in the execution segments.

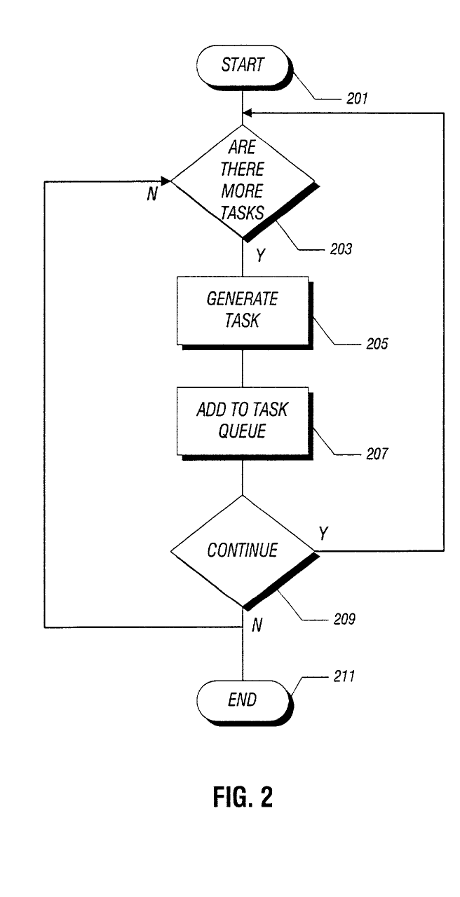

FIG. 2 illustrates an overview flow chart of a process a particular thread goes through to generate tasks inside a taskq construct according to one embodiment of the invention. An owner thread, such as 113, 115 or 117 may begin to execute a taskq construct beginning at block 201.

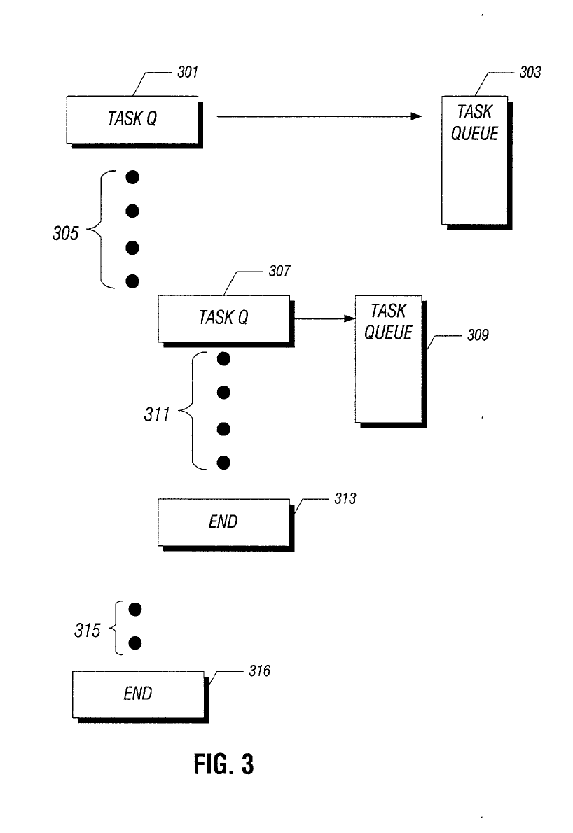

Once the owner thread has entered a taskq construct, the thread may determine whether there are more tasks to generate, block 203. If more tasks are available to generate, then the thread may then generate a task, block 205, that is added to a task queue, block 207, such as illustrated in FIG. 3 (303, 309).

After a task is added to a task queue, a determination may be made, block 209, as to whether the thread should continue to execute the taskq construct. If execution is to continue, execution flow may return to block 203 in some embodiments. Otherwise, the thread may save its persistent state information and exit the routine. If at block 203 a determination is made that there are no more tasks to be generated in the taskq construct, then the subroutine may be exited at block 211.

A taskq construct is reentrant and the construct may be entered and exited multiple times as required. To provide for reentrance, a thread may remember where it was when it left execution of the construct and may start execution at the same place when execution of the construct is called for again. This may be accomplished by storing persistent state variables as required. Should a new thread subsequently execute the same taskq construct, the new thread may use the persistent variables stored by the prior thread to begin executing the taskq construct at the same place the prior thread stopped.

FIG. 3 illustrates how two stacked taskq constructs (301, 316) and (307, 313) may be nested in some embodiments of the invention. In this example, Taskq construct 307, 313 is nested within the taskq construct 301, 316. While two nested taskq constructs are illustrated, more than two taskq constructs may be nested in some embodiments. Elements 305, 311 and 315 represent other instructions that may be present in the code in some embodiments.

In some embodiments, a taskq task has a task queue associated with it. For example, taskq 301 may have associated with it task queue 303 and taskq 307 may have associated with it task queue 309. Tasks that are generated by the execution of the taskq task 310 structure may be placed in taskq 303. In like manner, tasks generated by the execution of taskq structure 307 may be placed in taskq 309.

In one embodiment of the present invention, a particular thread such as 113, 115, or 117 may own task queue 303 in which case task queue 303 may be part of the thread activation list 119, 121, or 123. For example, if thread 113 owned the taskq structure (301,316), then, the task queue 303 may be owned by thread 113.

Each thread started by the computer system may begin and continue to execute tasks from its own activation list until such time as its activation list is empty of active tasks. A thread without an active task may be considered idle. An idle thread may then go into a work stealing mode, which permits an otherwise idle thread to execute any task on any queue.

Work stealing is an important concept in systems that permit the dynamic creation of nesting of parallelism. Given the typical varying amounts of dynamic parallelism available in different parts of the program and, at different levels of nesting, work stealing may allow a computing system to be considerably more computationally efficient.

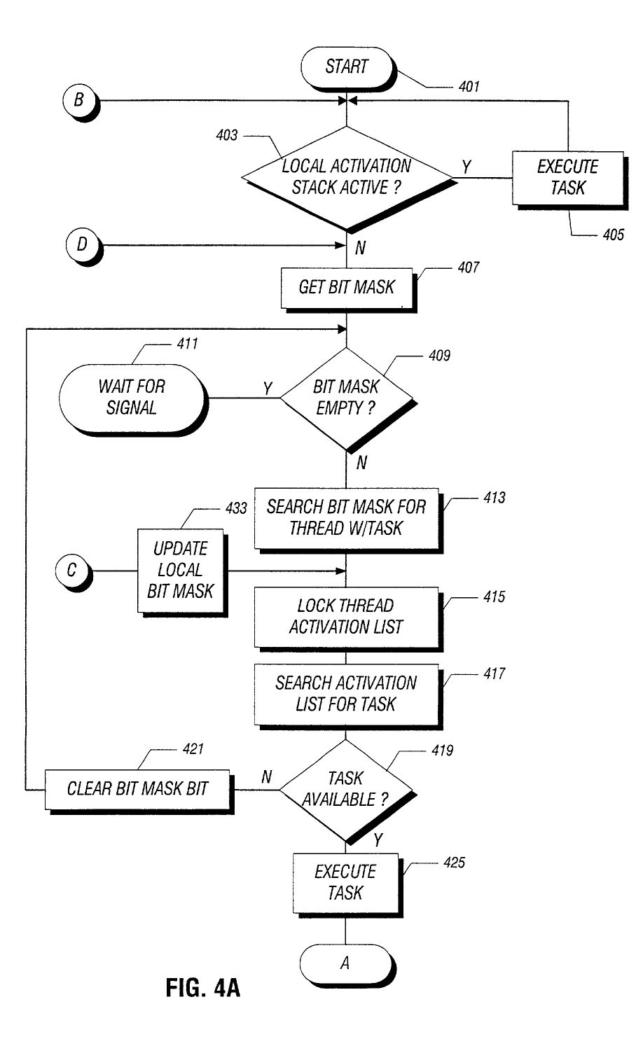

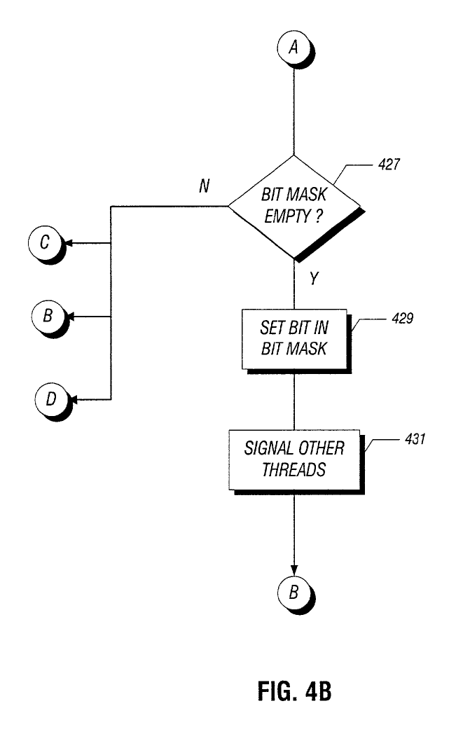

FIG. 4 illustrates an execution flow chart, which may be used by individual threads. A thread begins execution at block 401 and determines at block 403 whether there is a task available in its local activation stack. This may be determined by a thread walking its local activation stack and looking for work to steal from itself. In other words, the thread determines whether there are any task that the thread may perform in its own activation stack.

If there is a task that it may execute, then that task may be performed by the thread, block 405. After the task is executed, the thread may return to block 403 to determine if there are any other tasks that it can perform from its own activation stack. If no other tasks are found, then the thread may be idle.

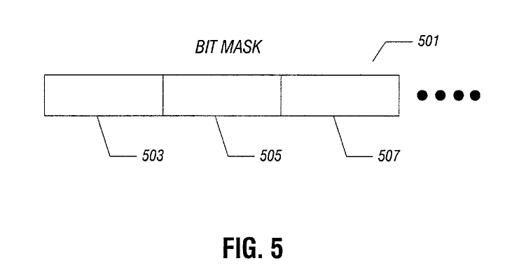

To indicate that the thread is now idle, the thread and may lock a data-structure in a central repository, and remove itself from a work flow bit mask. A portion of a bit mask, according to some embodiments, is illustrated in FIG. 5.

An idle thread may then go into a work steal mode. In some embodiments, the idle thread gets a copy of a bit mask, block 407, and may copy the bit mask into a local storage area. The thread may then determine if the bit mask is empty, block 409. If the bit mask is empty, the thread may release the lock on the repository and wait for an activation signal, block 411 (thread enters a “wait state”).

If a bit mask is not empty, that may mean there may be other tasks that may be performed in some other thread's queue. In some embodiments, the thread releases the lock on the data-structure and then begins a search for a task on another thread's activation queue, block 413.

In one embodiment of the present invention, a thread may search for tasks by inspecting a bit in the bit mask associated with a thread to its right. If the thread adjacent to it on the right does not have its mask bit set, then the thread looks to the next most right bit associated with the next most right thread and so on (modulo N, where N is the number of bits associated with particular threads). In other embodiments, a thread may search the bit mask in a different pattern such as looking at its left most neighbor etc. In still other embodiments, a thread my search the bit mask skipping one or more bits according to a search algorithm.

Once a thread has determined that another thread may have a task that can be executed, the thread may obtain a lock on the activation stack of the thread that has a bit indicating there may be tasks that may be performed, block 415. The thread may then begin to search the locked activation list for a task for it to execute, block 417.

It should be noted that the bit mask is a speculative mechanism. That means, if a bit indicates that a particular thread has a task that may be executed, there may or may not, in fact, be a task that is pending for execution in that particular thread's activation stack.

In block 419, in some embodiments, the thread determines if there is a task available in the locked activation list. Should a thread determine that there is not a task available, that is, the bit mask bit was speculative, then the thread may obtain a lock on the bit mask and clear the bit associated with the thread whose activation list the thread just searched and updates its copy of the bit mask, block 421. Then, in some embodiments, the thread may return to block 409 to search for work to steal.

In some embodiments, if at block 419, the thread determined that a task is available, then the thread releases the lock on the other thread's activation list and executes the task, block 415. If the task executed at block 425 was a taskq task which generates a new taskq task, then the new taskq is assigned to the executing thread and the thread may lock the bit mask, block 429, and may set the bit associated with the activation list from which the new taskq task was assigned if the bit was not already set.

Then, in block 431, the thread may signal to other threads that a task may now be available. The thread then may return to searching its own local activation stack, block 403, to examine its own local activation stack for tasks, etc.

If in block 425 the task executed was not a taskq task, or not a taskq task that generated a new taskq task, in some embodiments, the thread may return to block 403, path B, and begin examining its local activation stack. In other embodiments, the thread may return to block 415, path C, update its local copy of the bit mask, block 433, and once again search the activation list of the thread from which work was just obtained from.

However, many other possibilities exist. For example, the thread may return to block 407, path D, and once again cycle through the bit mask to find other tasks, which it may execute. In some embodiments, threads that are in a wait state, for example threads waiting at block 411, “wake up” when signaled by a thread in block 431 and begin looking for work that they may steal.

In an embodiment of the present invention, if a thread steals a task from another thread's activation list, and that task is a taskq task, any tasks generated therefrom are stored in the owner's activation list. For example, if thread 115 work steals a task from the activation stack 119 of thread 113, and that task was a taskq task, all tasks generated by the execution of the taskq task by thread 115 are stored in thread 113's activation list 119 and the bit 503 in the bit mask 501 associated with thread 113 is set to indicate that thread 113 may have tasks that other threads can steal.

Referring to FIG. 5, in some embodiments, a part of a bit mask 501, which includes three, bits 503, 505 and 507. Bit 503 may be associated with a first thread such as thread 113, bit 505 may be associated with a second thread such as thread 115, and bit 507 may be associated with a third thread such as thread 117. In block 407 and 409 of FIG. 4, a thread may obtain a copy of bit mask 501 and examine bits 503, 505 and 507 to see if any of the bits are set. A set bit can be either a one or a zero to depending on the particular system implementation chosen. Of course, the assignment of bits in the bit mask 501 is also implementation specific and may differ from that illustrated. For example, bit 507 may be associated with thread 113 and bit 505 may be associated with thread 117.

As described above, if a thread 115 associated with bit 505 wanted to determine if there was other work to steal, it may examine bit 507 to see if it is set. If that bit is set which indicates that there may be work to steal, then the thread 115 may obtain a lock on thread 117's activation stack as is described in association with FIG. 4.

As noted above, the particular search algorithm a thread used to determine if there may be work to steal is implementation specific. However, it may be preferred that the algorithm utilized is one that minimizes the creation of hot spots. A hot spot is where tasks are stolen more often from one thread rather than being evenly distributed among all the threads. The use of a search algorithm that results in a hot spot may sub-optimize the execution of the entire program.

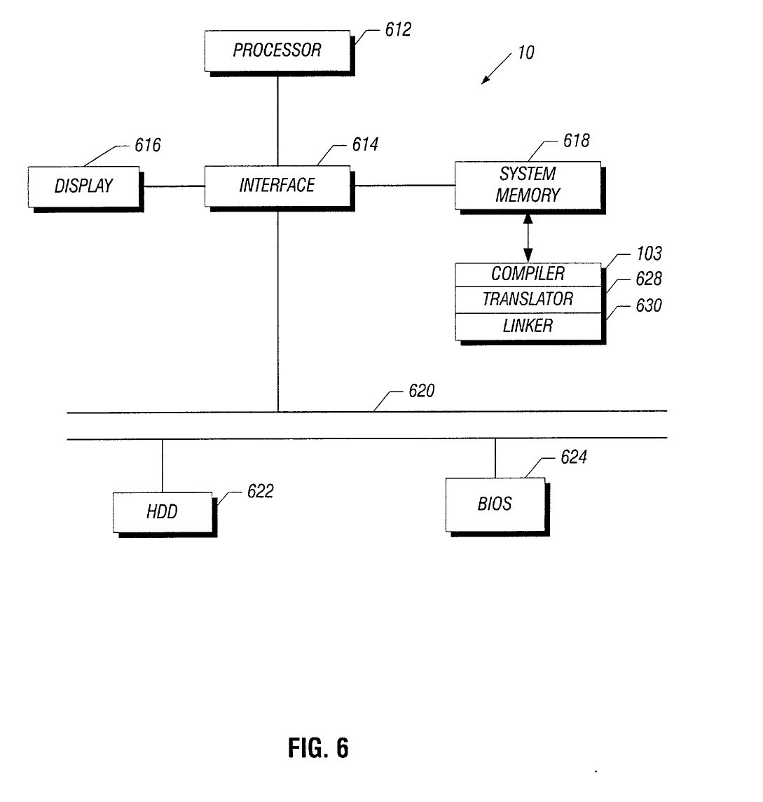

Referring to FIG. 6, a processor-based system 610 may include a processor 612 coupled to an interface 614. The interface 614, which may be a bridge, may be coupled to a display 616 or a display controller (not shown) and a system memory 618. The interface 614 may also be coupled to one or more storage devices 622, such as a floppy disk drive or a hard disk drive (HDD) as two examples only.

The storage devices 622 may store a variety of software, including operating system software, compiler software, translator software, linker software, run-time library software, source code and other software.

For the purposes of this specification, the term “machine-readable medium” shall be taken to include any mechanism that provides (i.e., stores and/or transmits) information in a form readable by a machine (e.g., a computer). For example, a machine-readable medium includes, but is not limited to, read only memory (ROM); random access memory (RAM); magnetic disk storage media, optical storage media; flash memory devices.

A basic input/output system (BIOS) memory 624 may also be coupled to the bus 620 in one embodiment. Of course, a wide variety of other processor-based system architectures may be utilized. For example, multi-processor based architectures may be advantageously utilized.

The compiler 103, translator 628 and linker 630, may reside totally or partially within the system memory 618. In some embodiments, the compiler 103, translator 628 and linker 630 may reside partially within the system memory 618 and partially in the storage devices 622.

While the preceding description contains many specifics, these should not be construed as limitations on the scope of the invention, but rather as an exemplification of one or a few embodiments thereof.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
creating a first stack of tasks associated with a first thread;
creating a second stack of tasks associated with a second thread;
executing tasks on the first stack of tasks with the first thread;
determining if the second stack of tasks contains a queued task executable by the first thread; and
executing a queued task in the second stack by the first thread.

2. The method as in claim 1 further comprising determining the second stack of tasks has a queued task includes examining a bit mask.

3. The method as in claim 2 further comprising locking the bit mask before the bit mask is examined.

4. The method as in claim 2 further comprising searching the second stack of tasks to determine if the second stack of tasks has a queued task.

5. The method as in claim 4 further comprising locking the second stack of tasks by the first thread before it is searched.

6. The method as in claim 2 further comprising changing a bit in the bit mask associated with the second thread if a queued task is not on the second stack of tasks.

7. The method as in claim 1 further comprising determining if the executed queued task was a taskq task.

8. The method as in claim 7 further comprising changing a bit in a bit mask in response to executing a taskq task which generates additional tasks.

9. The method as in claim 8 further comprising providing a signal to another thread that an additional task was generated.

10. The method as in claim 8 wherein changing the bit in the bit mask includes changing a bit associated with the second thread indicating the second stack of tasks contains a task executable by the first thread.

11. The method as in claim 1 further comprising executing all executable tasks on the first stack of tasks before determining if the second stack of tasks contains a queued task.

12. The method as in claim 11 further comprising causing the first thread to enter a wait state if the second stack of tasks does not contain a queued task executable by the first thread.

13. The method as in claim 12 further comprising causing the first thread to exit the wait state in response to another thread executing a task generating task.

14. A method comprising:
creating a plurality of threads each having a stack of queued tasks;
at least one thread executing tasks on its stack of queued tasks until no queued task remains in its stack of queued tasks that is executable by the thread and thereby becoming an idle thread;
at least one idle thread searching a bit mask for a bit that is set indicating a thread that may have a task executable by an idle thread;
in response to a set bit in the bit mask, at least one idle thread searching the stack of queued tasks owned by another thread for an available queued task that can be executed by the searching thread; and
if an available executable task is found, then an idle thread executes the available task.

15. The method as in claim 14 further comprising changing a bit in the bit mask if an executable task is not found.

16. The method as in claim 14 further comprising setting a bit in the bit mask if the available executable task is a task generating task which generates an additional task.

17. The method as in claim 16 further comprising enabling an idle thread to search its stack of queued tasks for an available task that is executable in response to the setting of a bit in the bit mask.

18. The method as in claim 14 further comprising queuing a task generated by the execution of a task generating task on the stack of queued tasks from which the task generating task was found.

19. The method as in claim 14 further comprising in response to the idle thread executing an available executable task, the idle thread searching its stack of queued tasks for an available task that is executable.

20. The method as in claim 14 further comprising an idle thread entering a wait state in response to the idle thread not finding a bit set in the bit mask.

21. A machine-readable medium that provides instructions, which when executed by a set of one or more processors, enable the set of processors to perform operations comprising:
creating a first stack of tasks associated with a first thread;
creating a second stack of tasks associated with a second thread;
executing tasks on the first stack of tasks with the first thread;
determining if the second stack of tasks contains a queued task executable by the first thread; and
executing a queued task in the second stack by the first thread.

22. The machine-readable medium of claim 21 wherein determining the second stack of tasks has a queued task is determined, in part, by examining a bit mask, and in response to a state of a bit in the bit mask, searching the second stack of tasks for a queued task.

23. The machine-readable medium of claim 22 wherein the bit mask has a bit associated with the second thread and the bit is changed if a queued task is not on the second stack of tasks.

24. The machine-readable medium of claim 21 further comprising determining if the executed queued task was a task generating task and changing a bit in the bit mask in response to executing a task generating task that generates an additional task.

25. The machine-readable medium of claim 24 wherein changing the bit in the bit mask includes changing a bit associated with the second thread indicating the second stack of tasks contains a task executable by the first thread.

26. The machine-readable medium of claim 24 further comprising enabling the first thread to enter a wait state if the second stack of tasks does not contain a queued task executable by the first thread and enabling the first thread to exit the wait state in response to another thread executing a task-generating task.

27. An apparatus comprising:
a memory including a shared memory location;
a set of at least one processors executing at least a first and second parallel thread;
the first thread having a first stack of tasks and the second thread having a second stack of tasks; and
the first thread determines if a queued task executable by the first thread is available on the second stack of tasks and the first thread executes an available task on the second stack of tasks.

28. The apparatus as in claim 27 wherein the first thread examines a bit mask to determine if the second stack of tasks has an available task and then searches the second stack of tasks for an available task.

29. The apparatus as in claim 28 wherein the first thread changes a bit in the bit mask associated with the second thread if the first thread executes an available task in the second stack that generates a task.

30. The apparatus as in claim 27 wherein if the first thread determines the second stack of tasks does not contain an available task, the first thread enters a wait state until a signal coupled to the first thread indicates an available task may be available.
